(19) United States
(12) Patent Application Publication
(10) Pub. No.: US 2026/0322469 A1
(43) Pub. Date: Oct. 15, 2026

(54) METHOD EXECUTED BY A WIRELESS COMMUNICATION DEVICE, WIRELESS COMMUNICATION DEVICE AND STORAGE MEDIUM

(71) Applicant: SAMSUNG ELECTRONICS CO., LTD., Suwon-si, Gyeonggi-do (KR)

(72) Inventors: Chen QIAN, Beijing (CN); Di SU, Beijing (CN); Peng LIN, Beijing (CN); Bin YU, Beijing (CN)

(21) Appl. No.: 19/144,177

(22) PCT Filed: Dec. 28, 2023
(86) PCT No.: PCT/KR2023/021916

§ 371 Date: Jun. 27, 2025

(30) Foreign Application Priority Data
Dec. 30, 2022 (CN) 202211742779.5

(51) Int. Cl. H04B 7/06; H04B 7/08; H04L 25/02

(52) U.S. Cl. CPC H04B 7/06956; H04B 7/086; H04L 25/0204

(57) ABSTRACT

The disclosure relates to a 5G or 6G communication system for supporting a higher data transmission rate. The present disclosure relates to a method executed by a wireless communication device, the wireless communication device and a storage medium. The wireless communication device includes a receiving antenna panel, the method includes: obtaining a first digital received signal; obtaining a second digital received signal; performing estimating for a received signal and/or sensing, based on the first digital received signal and the second digital received signal.

### TECHNICAL FIELD

The present disclosure relates to a field of communication, and specifically, relates to a method executed by a wireless communication device, the wireless communication device and a storage medium.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

In order to achieve a higher data rate, 5G communication systems are implemented in higher frequency (millimeter, mmWave) bands, e.g., 60 GHz bands. In order to reduce propagation loss of radio waves and increase a transmission distance, technologies such as beamforming, massive multiple-input multiple-output (MIMO), fulldimensional MIMO (FD-MIMO), array antenna, analog beamforming and large-scale antenna are discussed in 5G communication systems.

In addition, in 5G communication systems, developments of system network improvement are underway based on advanced small cell, cloud radio access network (RAN), ultra-dense network, device-to-device (D2D) communication, wireless backhaul, mobile network, cooperative communication, coordinated multi-points (CoMP), reception-end interference cancellation, etc.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Technical Problem

The present disclosure provides a method for obtaining a digital received signal executed by a wireless communication device.

### Solution to Problem

According to a first aspect of embodiments of the present disclosure, a method executed by a wireless communication device is provided, wherein the wireless communication device includes a receiving antenna panel, the method includes: obtaining a first digital received signal; obtaining a second digital received signal; performing estimating for a received signal and/or sensing, based on the first digital received signal and the second digital received signal, wherein the first digital received signal is obtained by performing sweeping for a first received beam or is obtained based on signals received by a plurality of sub-arrays of the receiving antenna panel, the second digital received signal is obtained by performing sweeping for a second received beam or is obtained based on signals received by the plurality of sub-arrays of the receiving antenna panel.

Alternatively, the method further includes: performing the beam sweeping with the first received beam; performing target detection according to the first digital received signal; performing beam sweeping with a next first received beam if no target is detected within coverage of the first received beam, wherein the obtaining of the first digital received signal includes: obtaining, for each first received beam, the first digital received signal, the obtaining of the second digital received signal includes: obtaining the second digital received signal if a target is detected within the coverage of the first received beam.

Alternatively, the receiving antenna panel is divided into the plurality of sub-arrays, the obtaining of the first digital received signal includes: obtaining the first digital received signal by performing a first combining on digital received signals obtained based on the signals received by the plurality of sub-arrays, the obtaining of the second digital received signal includes: obtaining the second digital received signal by performing a second combining on digital received signals obtained based on the signals received by the plurality of sub-arrays.

Alternatively, the obtaining of the first digital received signal by performing the first combining on the digital received signals obtained based on the signals received by the plurality of sub-arrays includes: obtaining the first digital received signal by summing the digital received signals obtained based on the signals received by the plurality of sub-arrays.

Alternatively, the obtaining of the second digital received signal by performing the second combining on the digital received signal obtained based on the signals received by the plurality of sub-arrays includes: performing phase rotation on a digital received signal obtained based on a signal received by at least one of the plurality of sub-arrays and summing the digital received signals of the plurality of sub-arrays after the phase rotation to obtain the second digital received signal.

Alternatively, the performing of the estimating for the received signal and/or the sensing, based on the first digital received signal and the second digital received signal includes: obtaining an angle estimation value for a target based on the first digital received signal and the second digital received signal.

Alternatively, the obtaining of the angle estimation value of the target based on the first digital received signal and the second digital receives signal includes: obtaining a first measurement value for the target according to the first digital received signal, obtaining a second measurement value for the target according to the second digital received signal, obtaining, based on the first measurement value and the second measurement value, the angle estimation value for the target.

Alternatively, the obtaining of the first measurement value for the target according to the first digital received signal includes: obtaining a first range-velocity spectrum according to the first digital received signal and obtaining the first measurement value for the target according to the first range-velocity spectrum; the obtaining of the second measurement value for the target according to the second digital received signal includes: obtaining a second range-velocity spectrum according to the second digital received signal and obtaining the second measurement value for the target according to the second range-velocity spectrum.

Alternatively, the obtaining of the angle estimation value for the target based on the first measurement value and the second measurement value includes: obtaining an angle deviation of a direction of the target from a current beam sweeping direction based on the first measured value and the second measured value, obtaining the angle estimation value for the target according to the angle deviation.

Alternatively, the obtaining of the angle deviation of the direction of the target from the current beam sweeping direction based on the first measured value and the second measured value includes: obtaining a result of performing a predetermined operation on the first measured value and the second measured value; obtaining the angle deviation of the direction of the target from the current beam sweeping direction according to a pre-established correspondence relationship between the result of the predetermined operation and the angle deviation, wherein the obtaining of the angle estimation value for the target according to the angle deviation includes: obtaining an initial angle estimation value for the target, and correcting the initial angle estimation value according to the angle deviation to obtain the angle estimation value for the target.

Alternatively, the receiving antenna panel is divided into the plurality of sub-arrays in a first direction and/or a second direction, wherein the obtaining of the angle estimation value for the target based on the first digital received signal and the second digital received signal includes: obtaining, an angle estimation value in the first direction and/or an angle estimation value in the second direction for the target, based on the first digital received signal and the second digital received signal.

Alternatively, the wireless communication device further includes: a digital processing unit, and analog-to-digital converters corresponding to respective sub-arrays of the plurality of sub-arrays, wherein the analog-to-digital converters are used for performing analog-to-digital conversion on signals received by the respective sub-arrays to obtain digital received signals for the respective sub-arrays, the digital processing unit is used for performing the first combining to obtain the first digital received signal and for performing the second combining to obtain the second digital received signal.

Alternatively, the wireless communication device further includes a transmitting antenna panel and an isolation device, wherein the isolation device is provided between the transmitting antenna panel and the receiving antenna panel.

Alternatively, the wireless communication device further includes a plurality of transmitting antenna panels and isolation devices s, wherein the receiving antenna panel is a plurality of receiving antenna panels, the isolation device is provided between any two adjacent antenna panels among the plurality of transmitting antenna panels and the plurality of receiving antenna panels.

Alternatively, the method further includes: transmitting a signal using the transmitting antenna panel; performing self-interference cancellation operation before obtaining the first digital received signal and the second digital received signal.

Alternatively, the performing of the estimating for the received signal and/or the sensing, based on the first digital received signal and the second digital received signal includes: performing channel estimating on the first digital received signal and the second digital received signal respectively and combining the first digital received signal and the second digital received signal when performing channel equalising to obtain an estimation value for the received signal; or performing the channel estimating and the equalising on the first digital received signal and the second digital received signal respectively and combining the first digital received signal and the second digital received signal when performing signal demodulating to obtain the estimation value for the received signal; or performing the channel estimating, the channel equalising and demodulation decoding on the first digital received signal and the second digital received signal respectively, and combining signals after the decoding to obtain the estimation value for the received signal.

Alternatively, the first received beam is a sum beam and the second received beam is a differential beam.

According to a second aspect of embodiments of the present disclosure, there is provided a wireless communication device including: a receiving antenna panel; a digital processing unit configured to: obtain a first digital received signal; obtain a second digital received signal; perform estimating for a received signal and/or sensing, based on the first digital received signal and the second digital received signal, wherein the first digital received signal is obtained by performing beam sweeping with a first received beam or is obtained based on signals received by a plurality of sub-arrays of the receiving antenna panel, the second digital received signal is obtained by performing beam sweeping with a second received beam or is obtained based on signals received by the plurality of sub-arrays of the receiving antenna panel.

Alternatively, the receiving antenna panel is configured to perform the beam sweeping with the first received beam; the digital processing unit is further configured to: perform target detection according to the first digital received signal; perform beam sweeping with a next first received beam if no target is detected within coverage of the first received beam, wherein the obtaining of the first digital received signal includes: obtaining, for each first received beam, the first digital received signal, the obtaining of the second digital received signal includes: obtaining the second digital received signal if a target is detected within the coverage of the first received beam.

Alternatively, the receiving antenna panel is divided into the plurality of sub-arrays, the obtaining of the first digital received signal includes: obtaining the first digital received signal by performing a first combining on digital received signals obtained based on the signals received by the plurality of sub-arrays, the obtaining of the second digital received signal includes: obtaining the second digital received signal by performing a second combining on digital received signals obtained based on the signals received by the plurality of sub-arrays.

Alternatively, the obtaining of the first digital received signal by performing the first combining on the digital received signals obtained based on the signals received by the plurality of sub-arrays includes: obtaining the first digital received signal by summing the digital received signals obtained based on the signals received by the plurality of sub-arrays.

Alternatively, the obtaining of the second digital received signal by performing the second combining on the digital received signal obtained based on the signals received by the plurality of sub-arrays includes: performing phase rotation on a digital received signal obtained based on a signal received by at least one of the plurality of sub-arrays and summing the digital received signals of the plurality of sub-arrays after the phase rotation to obtain the second digital received signal.

Alternatively, he performing of the estimating for the received signal and/or the sensing, based on the first digital received signal and the second digital received signal includes: obtaining an angle estimation value for a target based on the first digital received signal and the second digital received signal.

Alternatively, the obtaining of the angle estimation value of the target based on the first digital received signal and the second digital receives signal includes: obtaining a first measurement value for the target according to the first digital received signal, obtaining a second measurement value for the target according to the second digital received signal, obtaining, based on the first measurement value and the second measurement value, the angle estimation value for the target.

Alternatively, the obtaining of the first measurement value for the target according to the first digital received signal includes: obtaining a first range-velocity spectrum according to the first digital received signal and obtaining the first measurement value for the target according to the first range-velocity spectrum; the obtaining of the second measurement value for the target according to the second digital received signal includes: obtaining a second range-velocity spectrum according to the second digital received signal and obtaining the second measurement value for the target according to the second range-velocity spectrum.

Alternatively, the obtaining of the angle estimation value for the target based on the first measurement value and the second measurement value includes: obtaining an angle deviation of a direction of the target from current beam sweeping direction based on the first measured value and the second measured value, obtaining the angle estimation value for the target according to the angle deviation.

Alternatively, the obtaining of the angle deviation of the direction of the target from the current beam sweeping direction based on the first measured value and the second measured value includes: obtaining a result of performing a predetermined operation on the first measured value and the second measured value; obtaining the angle deviation of the direction of the target from the current beam sweeping direction according to a pre-established correspondence relationship between the result of the predetermined operation and the angle deviation, wherein the obtaining of the angle estimation value for the target according to the angle deviation includes: obtaining an initial angle estimation value for the target, and correcting the initial angle estimation value according to the angle deviation to obtain the angle estimation value for the target.

Alternatively, the receiving antenna panel is divided into the plurality of sub-arrays in a first direction and/or a second direction, wherein the obtaining of the angle estimation value for the target based on the first digital received signal and the second digital received signal includes: obtaining, an angle estimation value in the first direction and/or an angle estimation value in the second direction for the target, based on the first digital received signal and the second digital received signal.

Alternatively, the wireless communication device further includes: a digital processing unit, and analog-to-digital converters corresponding to respective sub-arrays of the plurality of sub-arrays, wherein the analog-to-digital converters are used for performing analog-to-digital conversion on signals received by the respective sub-arrays to obtain digital received signals for the respective sub-arrays, the digital processing unit is used for performing the first combining to obtain the first digital received signal and for performing the second combining to obtain the second digital received signal.

Alternatively, the wireless communication device further includes a transmitting antenna panel and an isolation device, wherein the isolation device is provided between the transmitting antenna panel and the receiving antenna panel.

Alternatively, the wireless communication device further includes a plurality of transmitting antenna panels and isolation devices, wherein the receiving antenna panel is a plurality of receiving antenna panels, the isolation device is provided between any two adjacent antenna panels among the plurality of transmitting antenna panels and the plurality of receiving antenna panels.

Alternatively, the transmitting antenna panel is configured to transmit a signal; the digital processing unit is configured to perform self-interference cancellation operation before obtaining the first digital received signal and the second digital received signal.

Alternatively, the performing of the estimating for the received signal and/or the sensing, based on the first digital received signal and the second digital received signal includes: performing channel estimating on the first digital received signal and the second digital received signal respectively and combining the first digital received signal and the second digital received signal when performing channel equalising to obtain an estimation value for the received signal; or performing the channel estimating and the equalising on the first digital received signal and the second digital received signal respectively and combining the first digital received signal and the second digital received signal when performing signal demodulating to obtain the estimation value for the received signal; or performing the channel estimating, the channel equalising and demodulation decoding on the first digital received signal and the second digital received signal respectively, and combining signals after the decoding to obtain the estimation value for the received signal.

Alternatively, the first received beam is a sum beam and the second received beam is a differential beam.

According to a third aspect of embodiments of the present disclosure, there is provided a wireless communication device including: a receiving antenna panel; at least one controller coupled to the receiving antenna panel and configured to: obtain a first digital received signal; obtain a second digital received signal; perform estimating for a received signal and/or sensing, based on the first digital received signal and the second digital received signal, wherein the first digital received signal is obtained by performing aweeping of a first received beam or is obtained based on signals received by a plurality of sub-arrays of the receiving antenna panel, the second digital received signal is obtained by performing beam sweeping with a second received beam or is obtained based on signals received by the plurality of sub-arrays of the receiving antenna panel.

According to a fourth aspect of embodiments of the present disclosure, there is provided a computer readable storage medium storing instructions, wherein the instructions, when executed by at least one processor, cause the at least one processor to: obtain a first digital received signal; obtain a second digital received signal; perform estimating for a received signal and/or sensing, based on the first digital received signal and the second digital received signal, wherein the first digital received signal is obtained by performing weeping of a first received beam or is obtained based on signals received by a plurality of sub-arrays of a receiving antenna panel, the second digital received signal is obtained by performing beam sweeping with a second received beam or is obtained based on signals received by the plurality of sub-arrays of the receiving antenna panel.

### Advantageous Effects of Invention

The technical solutions provided by the embodiments of the present disclosure at least bring following advantageous effects: since a first digital received signal and a second digital received signal are obtained respectively, the first digital received signal is obtained by performing beam sweeping with a first received beam or is obtained based on signals received by a plurality of sub-arrays of the receiveing antenna panel, and the second digital received signal is obtained by performing beam sweeping with a second received beam or is obtained based on signals received by the plurality of sub-arrays of the receiving antenna pane, more accurate sensing and/or estimating for the received signal can be achieved or more accurate estimating for the received signal and/or sensing can be performed with less resource consumption, by performing estimating for the received signal and/or sensing based on two types of digital received signals.

It should be understood that the above general description and the following detail description are merely exemplary and illustrative without limiting the present disclosure.

### BRIEF DESCRIPTION OF DRAWINGS

The drawings here are incorporated into the description and constitute a part of the description, illustrate exemplary embodiments conforming to the present disclosure, explain a principle of the present disclosure together with the description, and do not constitute inappropriate definition for the present disclosure.

FIG. 1 illustrates an example wireless network 100 according to various embodiments of the present disclosure.

FIG. 2a and FIG. 2b illustrate an example wireless transmission path and an example wireless reception path according to the present disclosure.

FIG. 3a illustrates an example UE 116 according to the present disclosure.

FIG. 3b illustrates an example gNB 102 according to the present disclosure.

FIG. 4 is a flowchart illustrating a method performed by a wireless communication device according to embodiments of the present disclosure.

FIG. 5 illustrates a beam pattern of a sum beam and a differential beam.

FIG. 6 illustrates a schematic diagram of a sub-array structure.

FIG. 7 illustrates a schematic diagram of angle estimating performed by a wireless communication device according to embodiments of the present disclosure.

FIG. 8 illustrates a receiving antenna panel being divided into a plurality of sub-arrays in the horizontal direction.

FIG. 9 illustrates a receiving antenna panel being divided into a plurality of sub-arrays in a vertical direction.

FIG. 10 illustrates a receiving antenna panel being divided into a plurality of sub-arrays in the horizontal direction and the vertical direction.

FIG. 11 illustrates an example of a wireless communication device performing angle estimating according to an embodiment of the present disclosure.

FIG. 12 illustrates an example structure of a wireless communication device according to an embodiment of the present disclosure.

FIG. 13 illustrates another example structure of a wireless communication device according to an embodiment of the present disclosure.

FIG. 14 illustrates a block diagram of an example of a wireless communication device according to an embodiment of the present disclosure.

FIG. 15 illustrates a block diagram of another example of a wireless communication device according to an embodiment of the present disclosure.

### MODE FOR THE INVENTION

The description is provided below with reference to the accompanying drawings to facilitate comprehensive understanding of various embodiments of the present disclosure as defined by the claims and the equivalents thereof. This description includes various specific details to help with understanding but should only be considered illustrative. Consequently, those ordinarily skilled in the art will realize that various embodiments described here can be varied and modified without departing from the scope and spirit of the present disclosure. In addition, the description of function and structure of the common knowledge can be omitted for clarity and conciseness.

The terms and expressions used in the description and claims below are not limited to their lexicographical meaning but are used only by the inventor to enable the clear and consistent understanding of the present disclosure. Therefore, it should be apparent to those skilled in the art that the following description of the various embodiments of the present disclosure is provided only for the purpose of the illustration without limiting the present disclosure as defined by the appended claims and their equivalents.

It will be understood that, unless specifically stated, the singular forms “one”, “a”, and “said” include the plural form. Thus, for example, the reference to “component surface” includes the reference to one or more such the surfaces.

The terms “includes” and “may include” mean the presentation of the corresponding disclosed functions, operations, or components that can be used in various embodiments of the present disclosure, but do not limit the presentation of one or more additional functions, operations, or features. In addition, it should be understood that the terms “including” or “having” may be interpreted to mean certain features, numbers, steps, operations, components, assemblies or combinations thereof, but should not be interpreted to exclude the possibility of the existence of one or more of other features, numbers, steps, operations, components, assemblies and/or combinations thereof.

The term “or” as used in various embodiments of the present disclosure includes any listed term and all the combinations thereof. For example, “A or B” may include “A”, may include “B”, or may include both “A and B”.

Unless defined differently, all terms as used in the present disclosure (including technical or scientific terms) have the same meanings as understood by those skilled in the are as described in the present disclosure. As common terms defined in dictionaries are interpreted to have meanings consistent with those in the context in the relevant technical field, and they should not be idealized or overly formalized unless expressly defined as such in the present disclosure.

The exemplary embodiments of the present disclosure are further described below in conjunction with the accompanying drawings. The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

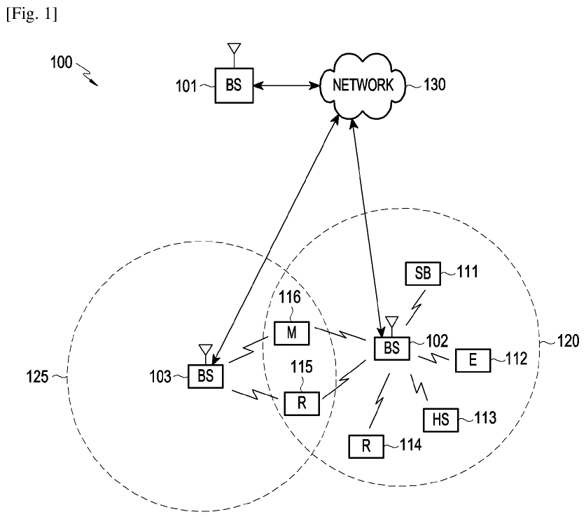

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a commonly considered fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. gNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

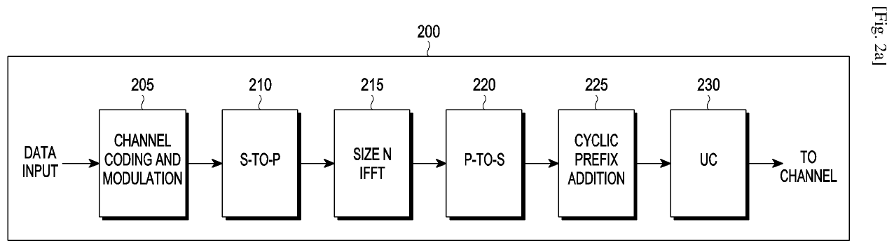

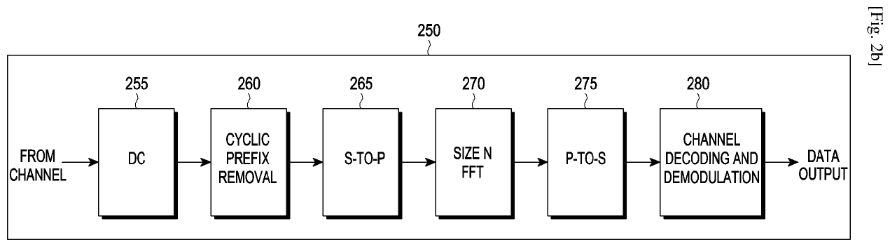

FIGS. 2a and 2b illustrate example wireless transmission reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2a and 2b can be implemented using only hardware, or using a combination of hardware and software/firmware. As a specific example, at least some of the components in FIGS. 2a and 2b may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2a and 2b illustrate examples of wireless transmission and reception paths, various changes may be made to FIGS. 2a and 2b. For example, various components in FIGS. 2a and 2b can be combined, further subdivided or omitted, and additional components can be added according to specific requirements. Furthermore, FIGS. 2a and 2b are intended to illustrate examples of types of transmission and reception paths that can be used in a wireless network. Any other suitable architecture can be used to support wireless communication in a wireless network.

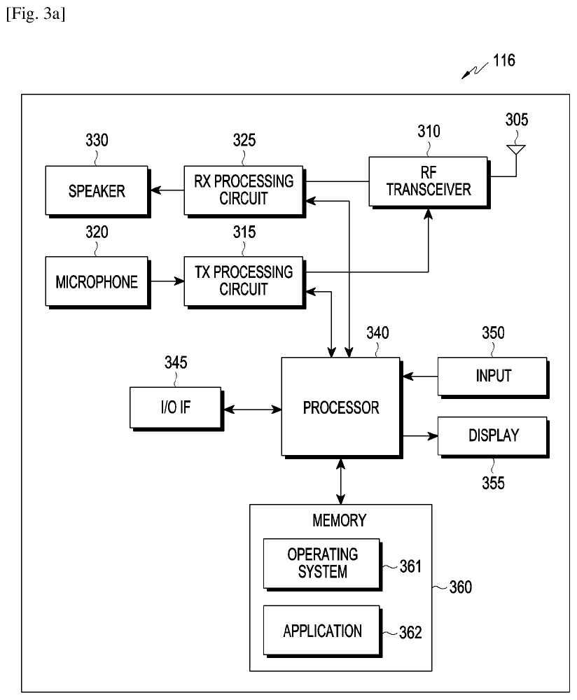

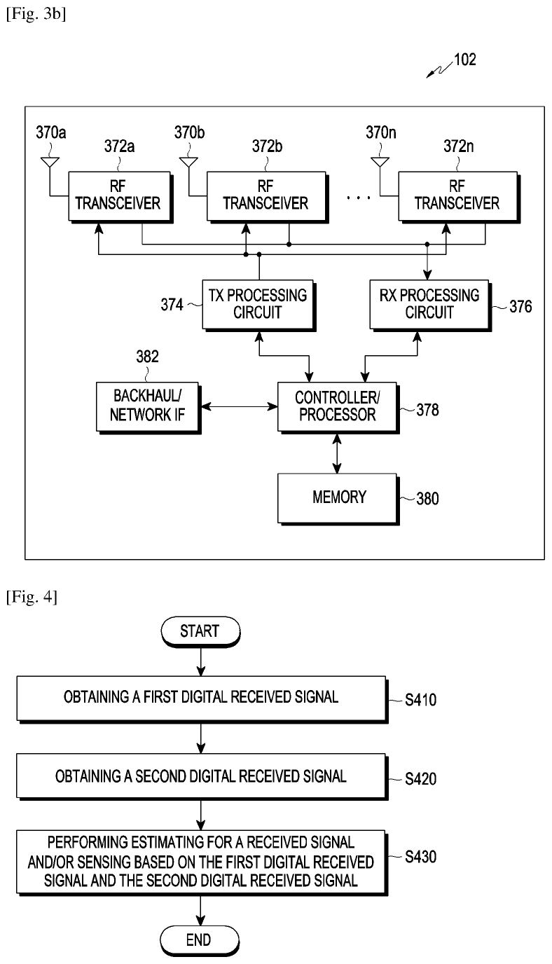

FIG. 3a illustrates an example UE 116 according to the present disclosure. The embodiment of UE 116 shown in FIG. 3a is for illustration only, and UEs 111-115 of FIG. 1 can have the same or similar configuration. However, a UE has various configurations, and FIG. 3a does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3a illustrates an example of UE 116, various changes can be made to FIG. 3a. For example, various components in FIG. 3a can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3a illustrates that the UE 116 is configured as a mobile phone or a smart phone, UEs can be configured to operate as other types of mobile or fixed devices.

FIG. 3b illustrates an example gNB 102 according to the present disclosure. The embodiment of gNB 102 shown in FIG. 3b is for illustration only, and other gNBs of FIG. 1 can have the same or similar configuration. However, a gNB has various configurations, and FIG. 3b does not limit the scope of the present disclosure to any specific implementation of a gNB. It should be noted that gNB 101 and gNB 103 can include the same or similar structures as gNB 102.

As shown in FIG. 3b, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3b illustrates an example of gNB 102, various changes may be made to FIG. 3b. For example, gNB 102 can include any number of each component shown in FIG. 3a. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

With advances in science technology, there are increasing kinds of communication devices. In addition to traditional devices such as a mobile phone and a computer, communication devices may also include mobile robots, for example, a self-driving vehicle, a drone and the like. Such type of mobile devices often need to have a capability to locate or be located so that a current situation is accurately identified and responding is taken, that is, they have a locating capability similar to that provided by radar technology. One straightforward way may be that the communication device is equipped with a radar module, however, as an operating band of a communication system has gradually moved to a band with higher frequency in recent years, the communication band has also moved closer to a radar band and the resulting interference and resource conflicts between the communication system and a radar system are inevitable. One concept to solve this problem may be considering a fusion system for communication and radar that is referred to an integrated sensing and communication technology to further enhance functionality of the communication system and improve spectrum efficiency. Currently, both industry and academia take the integrated sensing and communication as one of key technologies for future communication systems.

A core concept of the integrated sensing and communication is to use the same set of hardware devices to achieve a function for sensing surrounding environment at a cost of as few resources as possible while the basic communication function is ensured. In other words, a communication node also has a capability to sense, and what is sensed includes a distance, an orientation (angle), a velocity and even a type for an object in the surrounding environment. Unlike technology of locating access terminals in traditional communication systems, the integrated sensing and communication technology may also implement sensing for various types of information of a nonaccess object, which greatly increases a capability of the communication system to dynamically adjust its working state (scheduling, beam managing, early warning for an access terminal and the like) according to the surrounding environment. However, for existing integrated sensing and communication nodes, there is a problem that more accurate estimating for a received signal and/or sensing cannot be implemented, in addition, there is also a problem that resource consumption for implementing the estimating for a received signal and/or the sensing is larger.

To this, the present disclosure mainly relates to a sensing function and/or a communication function of an integrated sensing and communication node, and proposes a integrated sensing and communication node and a method performed by the integrated sensing and communication node, the integrated sensing and communication node and the method performed by the same according to an embodiment of the present disclosure are capable of implementing more accurate estimating for a received signal and/or sensing, or the integrated sensing and communication node and the method performed by the same according to an embodiment of the present disclosure are capable of implementing more accurate estimating for a received signal and/or sensing with less resource overhead. The integrated sensing and communication node is referred to hereinafter as a sensing node, which may be specifically any wireless communication device, for example, a base station, a terminal device, a bypass device and the like.

The most widely used communication systems are those based on the 3GPP protocol, for example, a 4G communication system such as an LTE and an LTE-A, and a 5G communication system such as a NR, signal waveforms used by these communication systems are waveforms modulated based on an OFDM. In view of forward compatibility, an OFDM communication signal may, for example, be used as a sensing signal. Specifically, the sensing signal may be a physical signal and/or a physical channel that may be used for a sensing purpose, for example, when the sensing node is a base station, the sensing signal may be a downlink reference signal or a downlink physical channel and the like; when the sensing node is a terminal, the sensing signal may be an uplink reference signal or an uplink physical channel and the like. The sensing signal sent by the sensing node is reflected by the target reflector and then rereceived by the sensing node in a form of an echo, and sensed information such as a distance, a velocity, an orientation for the target object may be sensed by signal processing for the echo signal.

Hereinafter, a method performed by a wireless communication device of an embodiment of the present disclosure is described with reference to FIGS. 4 to 13.

FIG. 4 is a flowchart illustrating a method performed by a wireless communication device according to an embodiment of the present disclosure.

According to an embodiment, the wireless communication device may include a receiving antenna panel. For example, the wireless communication device may operate in a millimeter wave band or a band with higher frequency. Referring to FIG. 4, at step S410, a first digital received signal is obtained. According to an embodiment, the first digital received signal is obtained by performing beam sweeping with a first received beam or based on signals received by a plurality of sub-arrays of the receiving antenna panel. At step S420, a second digital received signal for the receiving antenna panel is obtained. According to an embodiment, the second digital received signal is obtained by performing beam sweeping with a second received beam or based on signals received by the plurality of sub-arrays of the receiving antenna panel. For example, the first received beam may be a sum beam and the second receive beam may be a differential beam. Finally, at step S430, estimating for a received signal and/or sensing may be performed based on the first digital received signal and the second digital received signal.

In the method of FIG. 4, since the first digital received signal and the second digital received signal are obtained respectively, the first digital received signal is obtained by performing beam sweeping with a first received beam or based on signals received by a plurality of sub-arrays of the receiving antenna panel, and the second digital received signal is obtained by performing beam sweeping with a second received beam or based on signals received by the plurality of sub-arrays of the receiving antenna pane, more accurate estimating for the received signal and/or sensing can be achieved, or, more accurate estimating for the received signal and/or sensing can be performed with less resource consumption by performing the estimating for a received signal and/or the sensing based on the two digital received signals. For example, if the first digital received signal is obtained by performing beam sweeping with the first received beam and the second digital received signal is obtained by performing beam sweeping with the second received beam, more accurate estimating for the received signal and/or sensing can be implemented since estimating for the received signal and/or the sensing is based on the digital received signals (the first digital received signal and the second digital received signal) corresponding to two types of received beams respectively. For example, if the first digital received signal and the second digital received signal are obtained based on the signals received by the plurality of sub-arrays of the receiving antenna panel, since two different types of digital received signals may be obtained based on the signals received by the plurality of sub-arrays of the receiving antenna panel which make it possible to obtain the two different types of digital received signals by perform only beam sweeping with one type of received beam, and then the estimating for the received signal and/or the sensing is performed, more accurate estimating for the received signal and/or sensing can be performed with less resource consumption.

Hereafter, specific operations involved in steps described above will be described in more detail in connection with various embodiments.

The method according to FIG. 4 may perform the sensing, may perform the estimating for the received signal, and may also perform both the sensing and the estimating for the received signal.

In the following, relevant contents of performing the sensing according to an embodiment of the present disclosure are described firstly. Hereafter, the relevant contents of method for the sensing of embodiments of the present disclosure are described by taking performing the sensing being performing angle estimating as an example, however, performing the sensing in the present disclosure is not limited to performing the angle estimating, but may also include, for example, performing distance estimating, velocity estimating, and the like for a target.

According to an embodiment, alternatively, the method illustrated in FIG. 4 may further include: performing beam sweeping with the first received beam. For example, beam sweeping with a sum beam may be performed. Taking the receiving antenna panel as a linear array, beamforming coefficients for the sum beam may be:

$$[ 1 , {e}^{j 2 π sin ( θ ) d / λ} , ... , {e}^{j 2 π ( N - 1 ) sin ( θ ) d / λ} ] ,$$

wherein θ is a beam sweeping angle, d is an antenna element spacing, λ is a wavelength and N is the number of antenna elements.

With the beam sweeping with the first received beam, at step S410, for each first received beam, a first digital received signal may be obtained. Here, the first digital received signal is a digital received signal corresponding to the first received beam, for example, the first received beam may be a sum beam. The first digital received signal may be obtained based on an echo signal of a sensing signal, which is received with the sum beam.

After obtaining the first digital received signal, alternatively, the method illustrated in FIG. 4 may further include: performing target detection based on the first digital received signal. For example, for each first received beam, after the first digital received signal is obtained, a first range-velocity spectrum may be obtained based on the first digital received signal and the target detection may be performed based on the first range-velocity spectrum. For example, a two-dimensional discrete Fourier transform (2D-DFT) may be performed on the first digital received signal to obtain the first range-velocity spectrum. The x-axis and γ-axis of the range-velocity spectrum are distance and velocity, respectively, and a measured value (e.g., received power value) at each point in the range-velocity spectrum being higher indicates a higher probability that a target is present, so that the target detection may be performed based on the first range-velocity spectrum.

At step S420, if a target is detected within coverage of the received beam, a second digital received signal is obtained. For example, a second digital received signal may be obtained by performing beam sweeping with a second received beam. The second received beam may be for example a differential beam. Taking the receiving antenna panel being a linear array as an example, beamforming coefficients used for performing beam sweeping with the differential beam may be as follows:

$$[ 1 , {e}^{\frac{j 2 π sin ( θ ) d}{λ}} , ... , {e}^{\frac{j 2 π ( N / 2 - 1 ) sin ( θ ) d}{λ}} , - {e}^{\frac{j 2 π ( N / 2 ) sin ( θ ) d}{λ}} , ... , - {e}^{j 2 π ( N - 1 ) sin ( θ ) d / λ} ] ,$$

wherein θ is a beam sweeping angle, d is an antenna element spacing, λ is a wavelength and N is the number of antenna elements.

However, since, in the above example, performing beamforming when performing beam sweeping with the second received beam (e.g., beam sweeping with a differential beam) brings a certain amount of resource consumption, increasing of resource consumption will be caused if the second digital received signal is obtained by actually performing the beam sweeping with the second received beam. Accordingly, the present disclosure proposes to obtain the second digital received signal by not actually performing beam sweeping with the second received beam but artificially constructing a different received beam (the second received beam), thereby implementing angle estimating for the target with less resource consumption.

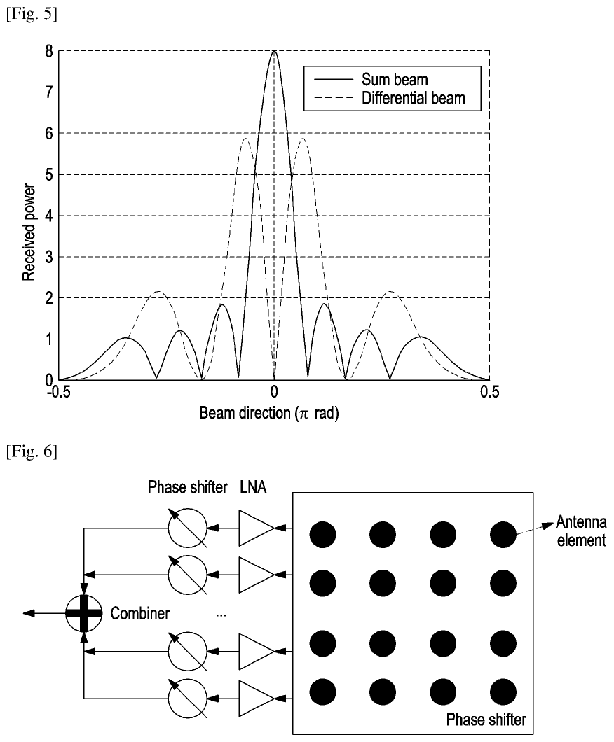

As can be seen from the beamforming coefficients above, compared to the beamforming coefficients for the sum beam, the first half of the beamforming coefficients for the differential beam are the same as the beamforming coefficients for the sum beam and the second half of the beamforming coefficients for the differential beam are opposite of the beamforming coefficients for the sum beam, and beam patterns for the sum beam and the differential beam are illustrated in FIG. 5. Based on enlightenment of beam difference bewtween the sum beam and the differential beam, the present disclosure proposes to obtain the first digital received signal and the second digital received signal respectively by dividing the receiving antenna panel into a plurality of sub-arrays and combining digital received signals obtained based on the plurality of sub-arrays respectively in different ways in a case of performing only beam sweeping with the first received beam, and then perform angle estimating for the target based on the first digital received signal and the second digital received signal, thereby enabling more accurate angle estimating to be acheived with less resource consumption.

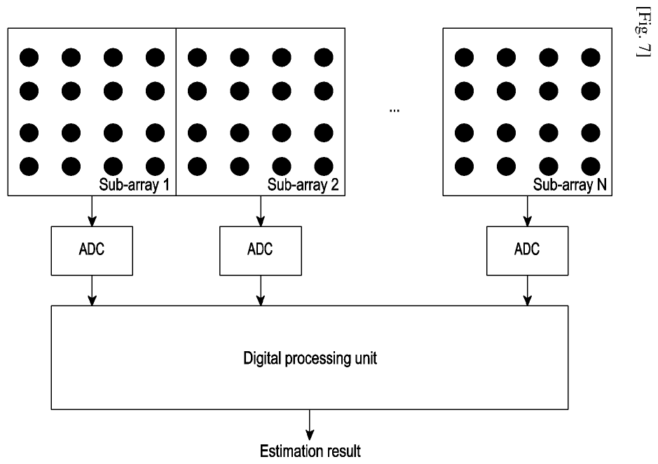

Specifically, according to an embodiment, the receiving antenna panel may be divided into a plurality of sub-arrays. FIG. 6 illustrates a schematic diagram of a structure of the sub-arrays. For example, each sub-array may be linked to a separate RF receiving link, wherein each sub-array includes a plurality of antenna units each of which is linked to a phase shifter and a low noise amplifier (LNA). By adjusting phase offset of the phase shifter, a direction for receiving beam of a receiving antenna array may be adjusted. Received signals received by a plurality of antenna units on the sub-array are combined into one analogue received signal by a combiner. FIG. 7 illustrates a schematic diagram of a wireless communication device performing angle estimating according to an embodiment of the present disclosure. As illustrated in FIG. 7, the wireless communication device may further include: a digital processing unit, and analog-to-digital converters (ADCs) corresponding to respective sub-arrays of the plurality of sub-arrays. The ADCs are used to perform analog-to-digital conversion on signals received by the respective sub-arrays to obtain digital received signals for the respective sub-arrays. For example, an analogue received signal into which received signals received by the plurality of antenna units on each sub-array are combined by a combiner is sent to an ADC linked to the each sub-array which converts the analogue received signal to a digital received signal, thereby obtaining a digital received signal for the each sub-array. Subsequently, the digital processing unit included in the wireless communication device may receive digital received signals obtained based on the respective sub-arrays and detect whether a target is present within beam sweeping range and obtain an angle estimation value for the target.

In a case that the receiving antenna panel is divided into the plurality of sub-arrays, step S410 illustrated in FIG. 4 may include: obtaining the first digital received signal by performing a first combining on digital received signals obtained based on the signals received by the plurality of sub-arrays. For example, the first digital received signal may be obtained by summing the digital received signals obtained based on the signals received by the plurality of sub-arrays. Furthermore, step S420 may include: obtaining the second digital received signal by performing a second combining on digital received signals obtained based on the signals received by the plurality of sub-arrays. For example, as illustrated in FIG. 7, the digital processing unit may perform the first combining to obtain the first digital received signal and perform the second combining to obtain the second digital received signal. It is equivalent to artificially constructing another received beam (the second received beam) to receive signals by performing the second combining on the digital received signals obtained based on the signals received by the plurality of subarrays which is different from the first combining, but actually the beam sweeping with the second received beam is not performed, and thus resource consumption may be saved. For example, phase rotation may be performed on a digital received signal obtained based on a signal received by at least one of the plurality of sub-arrays and the digital received signals of the plurality of sub-arrays after the phase rotation are summed to obtain the second digital received signal. As an example, when the receiving antenna panel is divided into two sub-arrays (sub-array 1 and sub-array 2), a digital received signal of the sub-array 1 may be left to be unchanged (which is equivalent to a phase rotation with 0 degrees), a sign of a digital received signal of the sub-array 2 is inverted (which is equivalent to a phase rotation with 180 degrees), and digital received signals of the sub-array 1 and sub-array 2 after the phase rotation are summed to obtain the second digital received signal. With the way described above, it is equivalent to take a difference between the digital received signal of the sub-array 1 and the digital received signal of the sub-array 2 as the second digital received signal.

As illustrated in FIG. 4, after obtaining the first digital received signal and the second digital received signal, at step S430, estimating for a received signal and/or sensing may be performed, based on the first digital received signal and the second digital received signal. For example, step S430 may include: obtaining an angle estimation value for a target based on the first digital received signal and the second digital received signal. According to an embodiment, for example, a first measurement value for the target may be obtained according to the first digital received signal, a second measurement value for the target may be obtained according to the second digital received signal, the angle estimation value for the target may be obtained based on the first measurement value and the second measurement value. Herein, there can be one or more targets.

Specifically, a first range-velocity spectrum may be obtained according to the first digital received signal and the first measurement value for the target may be obtained according to the first range-velocity spectrum. For example, a 2D-DFT may be performed on the first digital received signal to obtain the first range-velocity spectrum, and the target may be detected and the first measurement value for the target may be determined based on the first range-velocity spectrum. For example, the first measurement value may be a first received power value of a signal received via the first received beam after a sensing signal sent by the wireless communication device has been reflected by the target. In addition, a velocity estimation value and a distance estimation value for the target may be obtained and an initial angel estimation value for the target (i.e., the current beam sweeping angle) may be obtained, based on the first range-velocity spectrum.

In addition, a second range-velocity spectrum may be obtained according to the second digital received signal and the second measurement value for the target may be obtained according to the second range-velocity spectrum. For example, the second range-velocity spectrum may be obtained by performing a 2D-DFT on the second digital received signal, and a second measurement value for the target at the same coordinate position as a coordinate position of the target determined on the first range-velocity spectrum on the second range-velocity spectrum may be obtained according to the coordinate position, and thus a second measurement value for the target may be obtained. For example, the second measurement value may be a second received power value of a signal received via the second received beam after a sensing signal sent by the wireless communication device has been reflected by the target. Herein, the second received beam may be a second received beam when the beam sweeping with the second received beam is actually performed, or may be an artificially constructed virtual second received beam as mentioned above.

The angle estimation value for the target may be obtained based on the first measurement value and the second measurement value after obtaining the first measurement value and the second measurement value. For example, an angle deviation of a direction of the target from a current beam sweeping direction may be obtained based on the first measured value and the second measured value, the angle estimation value for the target may be obtained according to the angle deviation. For example, the obtaining of the angle deviation of the direction of the target from the current beam sweeping direction based on the first measured value and the second measured value may include: obtaining a result of performing a predetermined operation on the first measured value and the second measured value; obtaining the angle deviation of the direction of the target from the current beam sweeping direction according to a pre-established correspondence relationship between the result of the predetermined operation and the angle deviation. According to an embodiment, the predetermined operation may be a division operation, but is not limited thereto, for example, the predetermined operation may also be a subtraction operation and the like.

For example, a one-to-one correspondence relationship between a quotient obtained by the second measurement value dividing the first measurement value and an angle deviation may be pre-established. As an example, the one-to-one relationship may be represented by means of a look-up table, as shown in Table 1.

TABLE 1
table for obtaining an angle deviation

| quotient for the first measurement value | |
|---|---|
| and the second measurement value | angle deviation |
| a₁ | φ₁ |
| a₂ | φ₂ |
| a₃ | φ₃ |
| . . . | . . . |

In a case of the table described above being pre-established, a quotient for the first measurement value and the second measurement value may be calculated and an angle deviation corresponding to the quotient may be obtained by looking up a relationship in the table.

After obtaining the angle deviation for the current beam sweeping direction, the angle estimation value for the target may be obtained according to the angle deviation. Specifically, an initial angle estimation value for the target may be obtained, and the initial angle estimation value may be corrected according to the angle deviation to obtain the angle estimation value for the target. Herein, the initial angle estimation value for the target may be a current beam sweeping angle, and the angle estimation value for the target may be obtained by adding the initial angle estimation value to the obtained angle deviation.

According to an embodiment, the receiving antenna panel may be divided into the plurality of sub-arrays in a first direction and/or a second direction. For example, the first direction may be a horizontal direction and the second direction may be a vertical direction, but the first direction and the second direction are not limited to the above examples, but may be any possible division directions. In addition, the plurality of subarrays may have a same shape or different shapes. Furthermore, each sub-array may include a same number of antenna units or different numbers of antenna units. Accordingly, at step S430, an angle estimation value in the first direction and/or an angle estimation value in the second direction for the target may be obtained based on the first digital received signal and the second digital received signal. Hereafter, taking that the first direction is the horizontal direction and the second direction is the vertical direction as an example, the obtaining of an angle estimation value in the first direction and/or an angle estimation value in the second direction for the target based on the first digital received signal and the second digital received signal is described.

Specifically, if the receiving antenna panel is divided into the plurality of sub-arrays in the horizontal direction, an angle estimation value for the target in the horizontal direction may be obtained based on the first digital received signal and the second digital received signal. If the receiving antenna panel is divided into the plurality of sub-arrays in the vertical direction, an angle estimation value for the target in the vertical direction may be obtained based on the first digital received signal and the second digital received signal. If the receiving antenna panel is divided into the plurality of sub-arrays in both the horizontal direction and the vertical direction, an angle estimation value for the target in the horizontal direction and an angle estimation value for the target in the vertical direction may be obtained based on the first digital received signal and the second digital received signal.

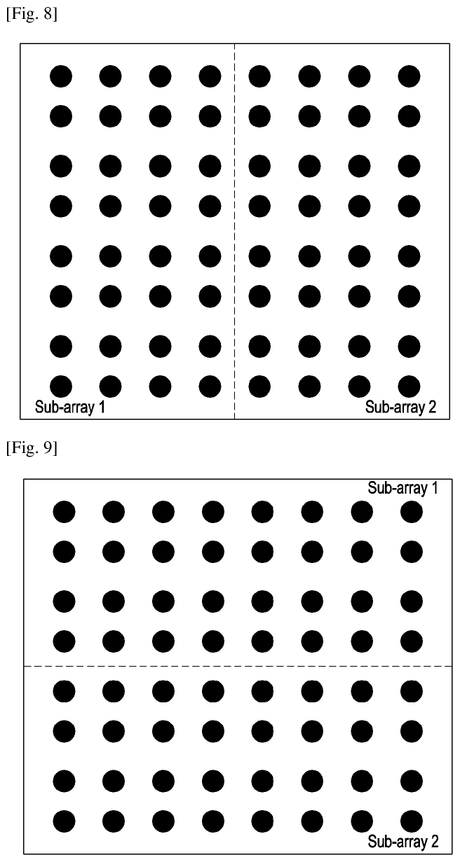

For example, as illustrated in FIG. 8, the receiving antenna panel may be divided into two sub-arrays in the horizontal direction. In this case, the angle estimation value for the target in the horizontal direction may be obtained based on the first digital received signal and the second digital received signal. For example, after an angle deviation corresponding to the quotient for the first measurement value and the second measurement value are obtained though the look-up table, the angle deviation may be used to correct the initial horizontal angle estimation value, and the corrected angle estimation value in the horizontal direction is a sum of the initial horizontal angle estimation value and the aforementioned angle deviation.

For example, as illusrated in FIG. 9, the receiving antenna panel may be divided into two sub-arrays in the vertical direction. In this case, an angle estimation value for the target in the vertical direction may be obtained based on the first digital received signal and the second digital received signal. For example, after an angle deviation corresponding to the quotient for the first measurement value and the second measurement value are obtained by the look-up table, the angle deviation may be used to correct the initial vertical angle estimation value and the corrected angle estimation value in the vertical direction is a sum of the initial vertical angle estimation value and the aforementioned angle deviation.

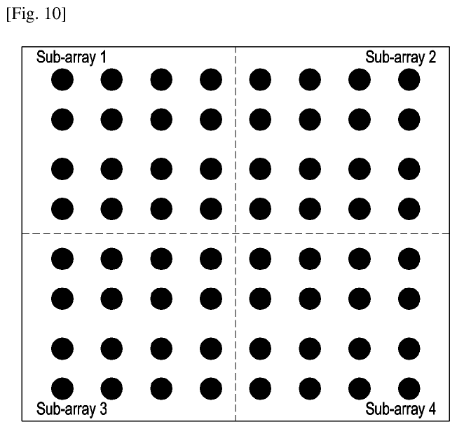

For example, as illustrated in FIG. 10, the receiving antenna panel is divided into four sub-arrays each of which includes a same number of antenna units, wherein subarrays 1, 3 and sub-arrays 2, 4 are divided in the horizontal direction and sub-arrays 1, 2 and sub-arrays 3, 4 are divided in the vertical direction. In this case, an angle estimation value for the target in the horizontal direction and an angle estimation value for the target in the vertical direction may be obtained based on the first digital received signal and the second digital received signal.

It should be noted that in the preceding examples, a two-dimensional receiving antenna panel is taken as an example. In fact, the method described in the present disclosure is equally applicable to a line array. It is also should be noted that: although a same number of antenna units are included in each sub-array in the divisions of FIGS. 8 to 10, the present disclosure is not limited thereto and respective antenna arrays may also include different numbers of antenna units, that is, the division of the receiving antenna panel may be a uniform division and may also be an uneven division.

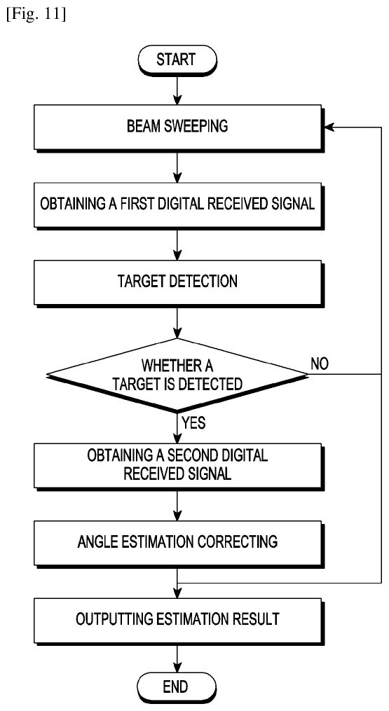

A manner in which the wireless communication device of the present disclosure performs angle estimating is further described below in connection with an example of FIG. 11. FIG. 11 illustrates an example of the wireless communication device performing angle estimating according to an embodiment of the present disclosure. As illustrated in FIG. 11, firstly, beam sweeping with a first received beam is performed, and for each first receive beam, a first digital received signal for the receiving antenna panel may be obtained by summing digital receive signals obtained respectively based on signals received by the plurality of sub-arrays of the receiving antenna panel. Next, target detection may be performed based on the first digital received signal. If it is not detected that a target is present within coverage of the first received beam, return to continue to perform the beam sweeping with the first received beam. If it is detected that a target is present within the coverage of the first received beam, phase rotation may be performed on a digital received signal obtained based on a signal received by at least one of the plurality of sub-arrays and the digital received signals of the plurality of sub-arrays after the phase rotation may be summed to obtain the second digital received signal. Subsequently, an angle estimation value for a target may be obtained based on the first digital received signal and the second digital received signal. For example, a first measurement value for the target may be obtained according to the first digital received signal, a second measurement value for the target may be obtained according to the second digital received signal, an angle deviation for the current beam sweeping direction may be obtained based on the first measured value and the second measured value, and then the initial angle estimation value is corrected according to the angle deviation to obtain a final angle estimation value for the target. The details involved in the above operations have been mentioned in the description before FIG. 11 and are not repeated here. After the angle estimation value is obtained, beam sweeping with a next first received beam may be continued. Alternatively, the estimation result may also be output.

As described above, the receiving antenna panel may be divided into the plurality of sub-arrays in the horizontal direction and/or the vertical direction. If the receiving antenna panel may be divided into four sub-arrays in the horizontal direction and the vertical direction as illustrated in FIG. 10, an example of performing angle estimating as illustrated in FIG. 11 may be as follows:

Firstly, the wireless communication device performs beam sweeping with a first received beam, the first digital received signal is obtained by summing the digital received signals obtained based on the signals received by the four sub-arrays of the receiving antenna panel for each first received beam, and subsequently a two-dimensional DFT is performed on the first digital received signal to obtain a first range-velocity spectrum, and whether one or more targets are present within the first received beam, coordinate positions of the one or more targets on the first range-velocity spectrum, the first measurement values corresponding to the one or more targets, and distances and radial velocities for the one or more targets are detected based on the first range-velocity spectrum, and a current beam direction is taken as initial angle estimation values in the horizontal direction and the vertical direction. If no target is detected within the received beam, beam sweeping with a next first received beam is continued. If it is detected that a target is present within the first received beam, the initial estimation values in the horizontal direction and the vertical direction are corrected to obtain angle estimation values in the horizontal direction and the vertical direction.

For example, digital received signals obtained based on the sub-array 1 and the sub-array 3 are summed to obtain a second digital received signal; digital received signals obtained based on the sub-array 2 and the sub-array 4 are summed to obtain a third digital received signal; and the second digital received signal is differenced from the third digital received signal to obtain a second measurement value. An angle deviation in the horizontal direction is obtained based on the first measurement value and the second measurement value. An angle estimation value in the horizontal direction is obtained according to the initial angle estimation value in the horizontal direction and the angle deviation in the horizontal direction.

Alternatively, digital received signals obtained based on the sub-array 1 and the sub-array 2 may also summed to obtain a fourth digital received signal; digital received signals obtained based on the sub-array 3 and the sub-array 4 are summed to obtain a fifth digital received signal; and the fourth digital received signal is differenced from the fifth digital received signal to obtain a third measurement value. An angle deviation in the vertical direction is obtained based on the first measurement value and the third measurement value. An angle estimation value in the vertical direction is obtained according to the initial angle estimation value in the vertical direction and the angle deviation in the vertical direction.

According to an embodiment, in order to obtain the angle estimation value in the horizontal direction and the angle estimation value in the vertical direction, an angle deviation look-up table for the horizontal direction, and an angle deviation look-up table for the vertical direction may be created in advance. For example, the angle deviation look-up table for the horizontal direction and the angle deviation look-up table for the vertical direction are created in advance, according to numbers of antenna units of respective receiving sub-arrays and beamforming coefficients that are used.

One possible angle deviation look-up table for the horizontal direction is a one-to-one correspondence relationship between a ratio of the first measurement value to the second measurement value and an angle deviation in the horizontal direction, one possible example is as shown in Table 2.

TABLE 2
angle deviation look-up table for the horizontal direction

| ratio of the first measurement value | angle deviation in the |
|---|---|
| to the second measurement value | horizontal direction |
| b₁ | β₁ |
| b₂ | β₂ |
| b₃ | β₃ |
| . . . | . . . |

One possible angle deviation look-up table for the vertical direction is a one-to-one correspondence relationship between a ratio of the first measurement value to the third measurement value and an angle deviation in the vertical direction, one possible example is as shown in Table 3.

TABLE 3
angle deviation look-up table for the vertical direction

| ratio of the first measurement value | angle deviation in the |
|---|---|
| to the third measurement value | vertical direction |
| c₁ | θ₁ |
| c₂ | θ₂ |
| c₃ | θ₃ |
| . . . | . . . |

Angle deviations for one or more targets in the horizontal direction may be obtained based on the obtained first measured values and the obtained second measured values for the one or more targets and the aforementioned angle deviation look-up table for the horizontal direction.

Angle deviations for one or more targets in the vertical direction may be obtained based on the obtained first measured values and the obtained third measured values for the one or more targets and the aforementioned angle deviation look-up table for the vertical direction.

The angle estimation values for the one or more targets in the horizontal direction may be obtained based on the aforementioned initial angle estimation value in the horizontal direction and the aforementioned angle deviations for the one or more targets in the horizontal direction.

The angle estimation values for the one or more targets in the vertical direction may be obtained based on the aforementioned initial angle estimation value in the vertical direction and the aforementioned angle deviations for the one or more targets in the vertical direction.

After obtaining the angle estimation values described above, beam sweeping with a next first received beam may be continued.

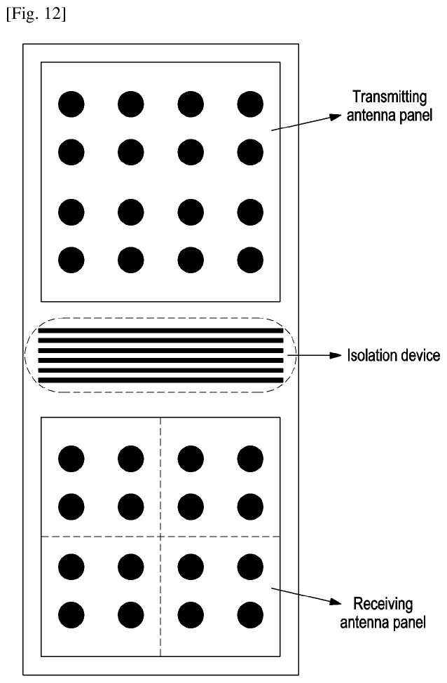

Alternatively, according to another embodiment, as illustrated in FIG. 12, in addition to including the receiving antenna panel, the wireless communication device described above may also include a transmitting antenna panel and an isolation device, wherein the isolation device is provided between the transmitting antenna panel and the receiving antenna panel to reduce interference existing between the transmitting antenna panel and the receiving antenna panel. For example, the isolation device is used for providing an isolation between a transmit signal and the receive signal to reduce interference of a transmitted signal to a received echo signal. For example, the transmitting antenna panel may be a conventional phase-compensated base array (phased array) structure, or other antenna array structure capable of producing an analogue beam. For example, the isolation device may consist of single or multiple parallel choke plates, or consist of an electromagnetic bandgap structure.

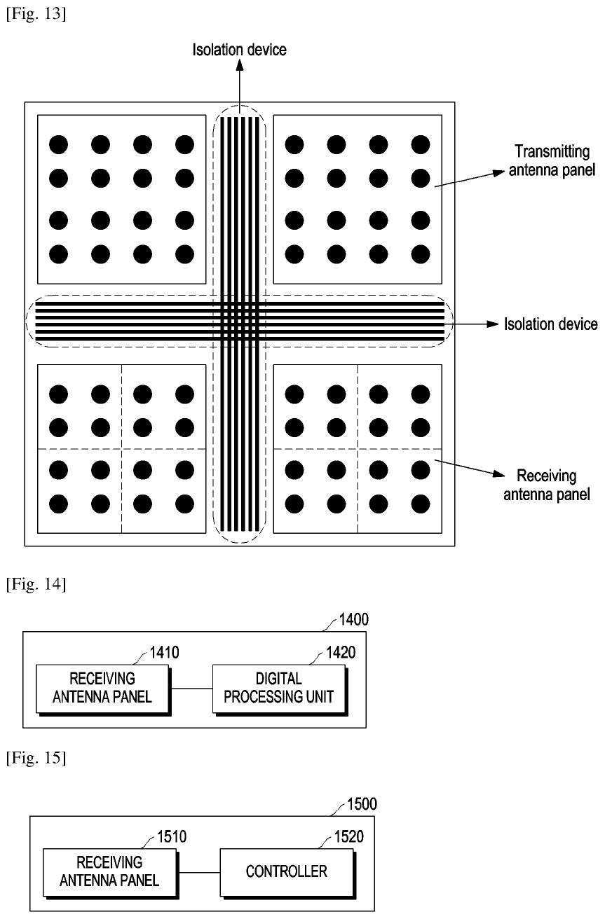

Alternatively, according to another embodiment, as illustrated in FIG. 13, in addition to including the receiving antenna panel, the wireless communication device described above may include a plurality of transmitting antenna panels and isolation devices, wherein the receiving antenna panel may be a plurality of receiving antenna panels, the isolation device is provided between any two adjacent antenna panels of the plurality of transmitting antenna panels and the plurality of receiving antenna panels to reduce interference existing between the antenna arrays. In other words, the isolation device is provided between different transmitting antenna arrays or receiving antenna arrays to reduce interference between the antenna arrays that may be present. Each transmitting antenna array may use a conventional antenna array structure capable of supporting analogue beam generation. The isolation device may be single or multiple parallel choke plates or electromagnetic bandgap structures. In the example illustrated in FIG. 13, the wireless communication device includes two transmitting antenna panels, two receiving antenna panels, and the two receiving antenna panels both use the dividing manner of sub-arrays described above. In addition, a choke plate may be used as an isolation device between each two adjacent antenna panels.

When the wireless communication device described above has the design structure illustrated in FIG. 12 or FIG. 13, alternatively, the method illustrated in FIG. 4 may further include: transmitting a signal using the transmitting antenna panel; performing self-interference cancellation operation before obtaining the first digital received signal and the second digital received signal. Effect of the transmitted signal on the received signal may be reduced by performing the self-interference cancellation operation. For example, one or more transmitting antenna panels may be used for transmitting signals in a transmitting time slot and one or more receiving antenna panels may be used for receiving signals in a receiving time slot, for example, beam sweeping with the received beam may be performed to receive signals, the first digital received signal and the second digital received signal may be obtained by performing different combining operations on digital received signals obtained based on signals received by a plurality of sub-arrays of the same receiving antenna panel, and then, the estimating for the received signal and/or the angle estimating may be performed based on the first digital received signal and the second digital received signal. To further improve accuracy of the estimating for the received signal and/or the angle estimating, alternatively, a self-interference cancellation operation may be performed before the first digital received signal and the second digital received signal are obtained. Specifically, for example, the self-interference cancellation may be performed by estimating a self-interference channel to reconstruct a self-interference signal and subtracting the reconstructed self-interference signal from the received signal.

Taking that the wireless communication device is a base station as an example, when the wireless communication device has the design structure illustrated in FIG. 12 or FIG. 13, for example, one or more transmitting antenna panels may be used to transmit a signal in a downlink time slot, and subsequently, one or more receiving antenna panels may be used to receive a signal, for example, beam sweeping with a received beam may be performed to receive the signal, the first digital received signal and the second digital received signal are obtained by performing different combining operations on digital received signals obtained based on signals received by the plurality of sub-arrays of the same receiving antenna panel, and subsequently, the estimating for the received signal and/or the angle estimating may be performed based on the first digital received signal and the second digital received signal. However, the wireless communication device is not limited to being a base station, but may also be a terminal device or a bypass device.

As mentioned in the description above with respect to FIG. 4, at step S430, estimating for a received signal and/or sensing is performed based on the first digital received signal and the second digital received signal. A description has been focused on performing the sensing by the wireless communication device according to an embodiment of the present disclosure above. Since the wireless communication device is a communication-sensing integrated node, it may perform a basic communication function in addition to a sensing function.

In the following, performing the estimating for the received signal by the wireless communication device according to an embodiment of the present disclosure is further described in connection with an example. Related content in connection with steps S410 to S430 mentioned when describing the angle estimating above is applicable to the estimating for the received signal here, and is therefore not repeated.

As described above, according to an embodiment, the receiving antenna panel may be divided into the plurality of sub-arrays, each of which, for example, obtains a corresponding digital received signal via an RF link including a combiner and an ADC. One simple example is that the receiving antenna panel is divied into a total of N subarrays: sub-array 1 . . . and subarray N. Each sub-array generates a digital received signal via the RF link, and thus a digital received signal 1 . . . a digital receive signal N are obtained. After obtaining digital received signals for respective sub-arrays, the digital received signals for respective sub-arrays may be combined according to predetermined criteria to obtain at least two combined digital received signals.

For example, a first digital received signal may be obtained by performing a first combining on digital received signals obtained based on signals received by the plurality of sub-arrays, and a second digital received signal may be obtained by performing a second combining on digital received signals obtained based on signals received by the plurality of sub-arrays.

The specific combining manner may be predetermined. For example, at least two sets of combining coefficients may be predetermined. Each set of combining coefficients is a vector whose length is N, each element of the vector is a complex number whose magnitude is 1 and whose phase is not 1. A mth combining coefficient is as follows:

$${a}_{m} = {[ exp ( j {θ}_{m 1} ) , exp ( j {θ}_{m 2} ) , ... , exp ( j {θ}_{mN} ) ]}^{T}$$

where θₘₘ denotes a phase shift coefficient of a nth sub-array in the mth combining coefficient.

To obtain a mth merged digital received signal, a digital received signal obtained based on each sub-array may be multiplied with a corresponding phase shift coefficient by using the mth combining coefficient and results are summed to obtain the mth merged digital received signal.

After obtaining the merged first digital received signal and the merged second digital received signal, the estimating for a received signal may be performed based on the first merged digital received signal and the second merged digital received signal, specifically, for example, channel estimating may be performed on the first digital received signal and the second digital received signal respectively and the first digital received signal and the second digital received signal may be merged when performing channel equalising to obtain an estimation value for the received signal; or the channel estimating and the equalising may be performed on the first digital received signal and the second digital received signal respectively and the first digital received signal and the second digital received signal may be merged when performing signal demodulating to obtain the estimation value for the received signal; or the channel estimating, the channel equalising and demodulation decoding may be performed on the first digital received signal and the second digital received signal respectively, and signals after the decoding may be merged to obtain the estimation value for the received signal. For example, a manner in which the first digital received signal and the second digital received signal are combined may be performing a maximum ratio combining and a manner of the demodulation may be an OFDM demodulation. The estimation value for the received signal may include estimation values of various parameters for the received signal.

One simple example is as follows. The receiving antenna panel is uniformly divided into two sub-arrays and in order to obtain the two merged digital received signals, the combining coefficients may be: [1, 1] and [1, −1] respectively. That is, the first digital received signal is a sum of digital received signals for the two sub-arrays, while the second digital received signal is a difference between the digital received signals for the two sub-arrays. After obtaining the merged two digital received signals, the OFDM demodulation and the channel estimating may be performed respectively, and then the maximum ratio combining may be performed to obtain an estimation value for the final received signal.

According to an embodiment, a first digital receive signal and a second digital receive signal are obtained (the first digital received signal is obtained by performing beam sweeping with a first received beam or is obtained based on signals received by a plurality of sub-arrays of the receiving antenna panel, the second digital received signal is obtained by performing beam sweeping with a second received beam or is obtained based on signals received by the plurality of sub-arrays of the receiving antenna panel) and the estimating for the received signal is performed based on the first digital received signal and the second digital received signal, and thus the accuracy of estimating for the received signal may be improved, or the accuracy of estimating for the received signal can be improved with less resource consumption.

The wireless communication method according to an embodiment of the present disclosure has been described above, and according to the wireless communication method described above, more accurate estimating for a received signal and/or sensing can be achieved. In addition, the wireless communication method according to an embodiment of the present disclosure also enables more accurate estimating for a received signal and/or sensing with less resource consumption.

FIG. 14 illustrates a block diagram of an example wireless communication device according to an embodiment of the present disclosure.

Referring to FIG. 14, the wireless communication device 1400 may include a receiving antenna panel 1410 and a digital processing unit 1420. The digital processing unit 1420 may be configured to: obtain a first digital received signal; obtain a second digital received signal; perform estimating for a received signal and/or sensing, based on the first digital received signal and the second digital received signal. According to an embodiment, the first digital received signal is obtained by performing beam sweeping with a first received beam or is obtained based on signals received by a plurality of sub-arrays of the receiving antenna panel 1410, the second digital received signal is obtained by performing beam sweeping with a second received beam or is obtained based on signals received by the plurality of sub-arrays of the receiving antenna panel 1410.

Since the method illustrated in FIG. 4 may be performed by the wireless communication device 1400 illustrated in FIG. 14 and the digital processing unit 1420 may perform steps S410-S430 in FIG. 4, any relevant details involved in the operations performed by the digital processing unit in FIG. 14 may refer to corresponding descriptions of FIG. 4 and FIGS. 5 to 13 above, none of which will be repeated here. Furthermore, other descriptions (e.g., the example of the structure of the wireless communication device and the like) of the wireless communication device prior to FIG. 14 are also applicable to the wireless communication device 1400 herein, none of which will be repeated herein.

FIG. 15 illustrates a block diagram of another example of a wireless communication device according to an embodiment of the present disclosure.

Referring to FIG. 15, the wireless communication device 1500 may include a receiving antenna panel 1510 and at least one controller 1520. The at least one controller 1520 may be coupled to the receiving antenna panel 1510 and configured to: obtain a first digital received signal; obtain a second digital received signal; perform estimating for a received signal and/or sensing, based on the first digital received signal and the second digital received signal. According to an embodiment, the first digital received signal is obtained by performing aweeping of a first received beam or is obtained based on signals received by a plurality of sub-arrays of the receiving antenna panel 1510, the second digital received signal is obtained by performing beam sweeping with a second received beam or is obtained based on signals received by the plurality of sub-arrays of the receiving antenna panel 1510.

Similarly, since the method illustrated in FIG. 4 may be performed by the wireless communication device 1500 illustrated in FIG. 15 and the at least one controller 1520 may perform steps S410-S430 in FIG. 4, any relevant details involved in the operations performed by the at least one controller 1520 in FIG. 15 may refer to corresponding descriptions of FIG. 4 and FIGS. 5 to 13 above, none of which will be repeated here. Furthermore, other descriptions (e.g., the example of the structure of the wireless communication device and the like) of the wireless communication device prior to FIG. 15 are also applicable to the wireless communication device 1500 herein, none of which will be repeated herein.

Furthermore, it should be noted that although the wireless communication device is divided into units for performing corresponding processings respectively when the wireless communication device is described above, it is apparent to those skilled in the art that a dividing manner for the units of the wireless communication device is not limited to the examples of FIG. 14 and FIG. 15, and is possible as long as it is capable of performing the method illustrated in FIG. 4.

According to an embodiment, the wireless communication device 1400 and the wireless communication device 1500 may be a wireless communication device at base station side, a wireless communication device at terminal side or a wireless communication device at bypass device side.

According to an embodiment of the present disclosure, there may also be provided a computer readable storage medium for storing instructions, wherein the instructions, when executed by at least one processor, cause the at least one processor to: obtain a first digital received signal; obtain a second digital received signal; perform estimating for a received signal and/or sensing, based on the first digital received signal and the second digital received signal, wherein the first digital received signal is obtained by performing weeping of a first received beam or is obtained based on signals received by a plurality of sub-arrays of a receiving antenna panel, the second digital received signal is obtained by performing beam sweeping with a second received beam or is obtained based on signals received by the plurality of sub-arrays of the receiving antenna panel. Examples of the computer-readable storage medium here include: Read Only Memory (ROM), Random Access Programmable Read Only Memory (PROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CDRW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, Hard Disk Drive (HDD), Solid State Drive (SSD), card storage (such as, multimedia cards, secure digital (SD) cards or extreme speed digital (XD) cards), magnetic tapes, floppy disks, magneto-optical data storage device, optical data storage device, hard disk, solid state disk, and any other devices that are configured to store computer programs and any associated data, data files and data structures in a non-transitory manner, and provide the computer programs and any associated data, data files and data structures to the processor or computer, so that the processor or computer may execute the computer programs. The instructions or computer programs in the above-mentioned computer-readable storage mediums may run in an environment deployed in a computer apparatus such as a client, a host, an agent device, a server, or the like. In addition, in one example, the computer programs and any associated data, data files and data structures are distributed on networked computer systems, so that the computer programs and any associated data, data files and data structures are stored, accessed, and executed in a distributed manner through one or more processors or computers.

Those skilled in the art will easily conceive of other implementation solutions of the present disclosure after considering the description and practicing the invention disclosed herein. The present application is intended to cover any modifications, uses, or adaptive changes of the present disclosure. These modifications, uses, or adaptive changes follow the general principles of the present disclosure and include common knowledge or customary technical means in the technical field that are not disclosed by the present disclosure. The description and the embodiments are only regarded as exemplary, and the true scope and spirit of the present disclosure are defined by the claims.

1. A method executed by a wireless communication device, wherein the wireless communication device comprises a receiving antenna panel, the method comprises:
obtaining a first digital received signal;
obtaining a second digital received signal;
performing estimating for a received signal and sensing, based on the first digital received signal and the second digital received signal, wherein the first digital received signal is obtained by performing beam sweeping with a first received beam or is obtained based on signals received by a plurality of sub-arrays of the receiving antenna panel, the second digital received signal is obtained by performing beam sweeping with a second received beam or is obtained based on signals received by the plurality of sub-arrays of the receiving antenna panel.

2. The method of claim 1, further comprising:
performing the beam sweeping with the first received beam;
performing target detection according to the first digital received signal;
performing beam sweeping with a next first received beam if no target is detected within coverage of the first received beam,
wherein the obtaining of the first digital received signal comprises:
obtaining, for each first received beam, the first digital received signal, the obtaining of the second digital received signal comprises: obtaining the second digital received signal if a target is detected within the coverage of the first received beam.

3. The method of claim 1, wherein the receiving antenna panel is divided into the plurality of sub-arrays,
the obtaining of the first digital received signal comprises: obtaining the first digital received signal by performing a first combining on digital received signals obtained based on the signals received by the plurality of sub-arrays,
the obtaining of the second digital received signal comprises: obtaining the second digital received signal by performing a second combining on digital received signals obtained based on the signals received by the plurality of sub-arrays.

4. The method of claim 3, wherein the obtaining of the first digital received signal by performing the first combining on the digital received signals obtained based on the signals received by the plurality of sub-arrays comprises:
obtaining the first digital received signal by summing the digital received signals obtained based on the signals received by the plurality of sub-arrays.

5. The method of claim 3, wherein the obtaining of the second digital received signal by performing the second combining on the digital received signal obtained based on the signals received by the plurality of sub-arrays comprises:
performing phase rotation on a digital received signal obtained based on a signal received by at least one of the plurality of sub-arrays and summing the digital received signals of the plurality of sub-arrays after the phase rotation to obtain the second digital received signal.

6. The method of claim 1, wherein the performing of the estimating for the received signal and/or the sensing, based on the first digital received signal and the second digital received signal comprises:
obtaining an angle estimation value for a target based on the first digital received signal and the second digital received signal.

7. The method of claim 6, wherein the obtaining of the angle estimation value for the target based on the first digital received signal and the second digital receives signal comprises:
obtaining a first measurement value for the target according to the first digital received signal,
obtaining a second measurement value for the target according to the second digital received signal,
obtaining, based on the first measurement value and the second measurement value, the angle estimation value for the target.

8. The method of claim 7, wherein the obtaining of the first measurement value for the target according to the first digital received signal comprises:
obtaining a first range-velocity spectrum according to the first digital received signal and obtaining the first measurement value for the target according to the first range-velocity spectrum;
the obtaining of the second measurement value for the target according to the second digital received signal comprises:
obtaining a second range-velocity spectrum according to the second digital received signal and obtaining the second measurement value for the target according to the second range-velocity spectrum.

9. The method of claim 7, wherein the obtaining of the angle estimation value for the target based on the first measurement value and the second measurement value comprises:
obtaining an angle deviation of a direction of the target from a current beam sweeping direction based on the first measured value and the second measured value,
obtaining the angle estimation value for the target according to the angle deviation.

10. The method of claim 9, wherein the obtaining of the angle deviation of the direction of the target from the current beam sweeping direction based on the first measured value and the second measured value comprises:
obtaining a result of performing a predetermined operation on the first measured value and the second measured value;
obtaining the angle deviation of the direction of the target from the current beam sweeping direction according to a pre-established relationship between the result of the predetermined operation and the angle deviation,
wherein the obtaining of the angle estimation value for the target according to the angle deviation comprises:
obtaining an initial angle estimation value for the target, and correcting the angle initial estimation value according to the angle deviation to obtain the angle estimation value for the target.

11. The method of claim 3, wherein the receiving antenna panel is divided into the plurality of sub-arrays in a first direction and/or a second direction,
wherein the obtaining of the angle estimation value for the target based on the first digital received signal and the second digital received signal comprises:
obtaining, an angle estimation value in the first direction and/or an angle estimation value in the second direction for the target, based on the first digital received signal and the second digital received signal.

12. The method of claim 3, wherein the wireless communication device further comprises: a digital processing unit, and analog-to-digital converters corresponding to respective sub-arrays of the plurality of sub-arrays,
wherein the analog-to-digital converters are used for performing analog-to-digital conversion on signals received by the respective sub-arrays to obtain digital received signals for the respective sub-arrays, the digital processing unit is used for performing the first combining to obtain the first digital received signal and for performing the second combining to obtain the second digital received signal.

13. The method of claim 1, wherein the performing of the estimating for the received signal and/or the sensing, based on the first digital received signal and the second digital received signal comprises:
performing channel estimating on the first digital received signal and the second digital received signal respectively and combining the first digital received signal and the second digital received signal when performing channel equalising to obtain an estimation value for the received signal; or
performing the channel estimating and the equalising on the first digital received signal and the second digital received signal respectively and combining the first digital received signal and the second digital received signal when performing signal demodulating to obtain the estimation value for the received signal; or
performing the channel estimating, the channel equalising and demodulation decoding on the first digital received signal and the second digital received signal respectively, and combining signals after the decoding to obtain the estimation value for the received signal.

14. A wireless communication device comprising:
a receiving antenna panel;
a digital processing unit configured to:
obtain a first digital received signal;
obtain a second digital received signal;
perform estimating for a received signal and sensing, based on the first digital received signal and the second digital received signal,
wherein the first digital received signal is obtained by performing beam sweeping with a first received beam or is obtained based on signals received by a plurality of sub-arrays of the receiving antenna panel, the second digital received signal is obtained by performing beam sweeping with a second received beam or is obtained based on signals received by the plurality of sub-arrays of the receiving antenna panel.

15. A computer readable storage medium storing instructions, wherein the instructions, when executed by at least one processor, cause the at least one processor to:
obtain a first digital received signal;
obtain a second digital received signal;
perform estimating for a received signal and/or sensing, based on the first digital received signal and the second digital received signal, wherein the first digital received signal is obtained by performing weeping of a first received beam or is obtained based on signals received by a plurality of sub-arrays of a receiving antenna panel, the second digital received signal is obtained by performing beam sweeping with a second received beam or is obtained based on signals received by the plurality of sub-arrays of the receiving antenna panel.
